(19) United States
(12) Patent Application Publication
(10) Pub. No.: US 2011/0144283 A1
(43) Pub. Date: Jun. 16, 2011

(54) COPOLYCARBONATE COMPOSITIONS HAVING IMPROVED THERMAL PROPERTIES AND BASED ON BLENDS

(75) Inventors: Helmut-Werner Heuer, Krefeld (DE); Rolf Wehrmann, Krefeld (DE)

(73) Assignee: Bayer MaterialScience AG, Leverkusen (DE)

(21) Appl. No.: 12/965,289

(22) Filed: Dec. 10, 2010

(30) Foreign Application Priority Data
Dec. 12, 2009 (EP) 09015398.2

(51) Int. Cl. C08L 69/00

(52) U.S. Cl. 525/390; 525/534

(57) ABSTRACT

The invention relates to compositions containing at least one copolycarbonate containing one or more bisphenol building blocks and one or more further specific (co)polycarbonates as well as compositions which optionally contain additives, the use thereof for the production of shaped articles, and shaped articles obtainable therefrom.

### RELATED APPLICATIONS

This application claims benefit to European Patent Application No. 09 015 398.2, filed Dec. 12, 2009, which is incorporated herein by reference in its entirety for all useful purposes.

### BACKGROUND OF THE INVENTION

The invention relates to compositions containing at least one copolycarbonate containing one or more bisphenol building blocks and one or more further specific (co)polycarbonates as well as compositions which optionally contain additives, the use thereof for the production of shaped articles, and shaped articles obtainable therefrom.

Copolycarbonates belong to the group consisting of the industrial thermoplastics. They have a wide range of applications in the electrical and electronic sector, as housing material of lights and in applications where particular thermal and mechanical properties are required, for example blow dryers, applications in the automotive sector, plastic covers, diffuser screens or waveguide elements and lamp covers or lamp bezels. These copolycarbonates can be used as blend components for further thermoplastics.

In the case of these compositions, the good thermal and mechanical properties, such as Vicat temperature (heat distortion resistance) and glass transition temperature, are virtually always essential. In order to achieve the high heat distortion resistance, it is necessary to rely on specific bisphenols which are complicated to synthesize and hence also expensive.

DE 102004020673 describes copolycarbonates having improved flowability and based on bisphenols having an ether or thioether linkage.

DE 3918406 discloses blends for optical data stores based on a specific polycarbonate with elastomers or other thermoplastics and the use thereof in optical applications, especially optical data stores, such as compact disks.

DE 102008023 800 describes the use of alkylphenols as chain terminators for reducing the nonuniformity U=(Mw/Mn)−1 in the preparation of copolycarbonates in a continuous process.

In methods known according to the prior art, the heat distortion resistance is achieved by the introduction of a specific building block based on 1,1-bis(4-hydroxyphenyl)-3,3,5-trimethylcyclohexane (Bisphenol TMC) into the polycarbonate backbone. This so-called high-Tg polycarbonate is expensive and considerably influences the economic factor.

However, the prior art contains no information for the person skilled in the art as to how, in the case of a specified/defined heat distortion resistance, he can reduce the amount of expensive high-Tg polycarbonate in PC blends which are prepared in a compounding step. In particular, there is no information regarding the influence of the blend component, especially the influence of the chain terminator in at least one or two blend components, on the heat distortion resistance of the total mixture.

It was therefore the object to provide compositions containing aromatic polycarbonates which have a smaller proportion of high-Tg polycarbonate with the same heat distortion resistance.

Surprisingly, it was found that compositions comprising specific (high-Tg) copolycarbonates (component A) with a (co)polycarbonate (component B) always require a smaller proportion of specific (high-Tg) copolycarbonate in order to achieve equally high heat distortion resistances when specially substituted chain terminators are present either in component A or component B or in both components. A synergistic effect arises with the use of these particular (co)polycarbonates which were prepared using specially substituted chain terminators.

This surprisingly applies to mixtures in a very large viscosity and Vicat range.

The novel property combinations described constitute an important criterion for the mechanical and thermal performance of the injection moulded or extruded component. Injection moulded parts or extrudates produced from the copolycarbonate compositions according to the invention have significantly improved thermal properties (Vicat temperature).

In the context of this application, polycarbonate compositions (or blends) are understood as meaning mixtures of two or more polycarbonates which may optionally be provided with additives (component C).

### EMBODIMENTS OF THE INVENTION

An embodiment of the present invention is a polycarbonate composition comprising:
A) from 5 to 90 parts by weight, based on the sum of the parts by weight of components A and B, of a copolycarbonate comprising one or more monomer units derived from compounds of the diphenol building block of formula (1)

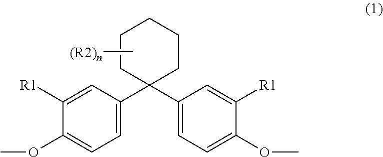

wherein
R1 is hydrogen or C₁-C₄-alkyl,
R2 is C₁-C₄-alkyl, and
n is 0, 1, 2 or 3,
and
B) from 95 to 10 parts by weight, based on the sum of the parts by weight of the components A and B, of a (co)polycarbonate comprising one or more monomer units of compounds of formula (2):

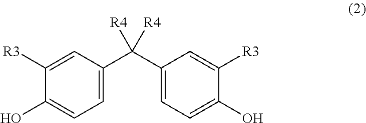

wherein
R3 is H or linear or branched C₁-C₁₀-alkyl, and
R4 is linear or branched C₁-C₁₀-alkyl,
wherein at least one of components A or B comprise, at least in part, a structural unit of formula (3)

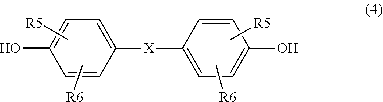

as a terminal group.
Another embodiment of the present invention is the above polycarbonate composition, wherein R1 is hydrogen, R2 is methyl, and n is 3.
Another embodiment of the present invention is the above polycarbonate composition, wherein at least one of components A or B additionally comprises monomer units based on diphenols of formula (4)

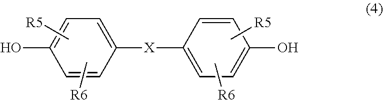

wherein
R5 and R6, are, independently of one another, hydrogen, C₁-C₁₈-alkyl, C₁-C₁₈-alkoxy, halogen, and optionally substituted aryl or aralkyl, and
X is a single bond, —SO₂—, —CO—, —O—, —S—, C₁- to C₆-alkylene, C₂- to C₅-alkylidene or C₅- to C₆-cycloalkylidene, wherein said C₁- to C₆-alkylene, C₂- to C₅-alkylidene, or C₅- to C₆-cycloalkylidene is optionally substituted with C₁-C₆-alkyl, or C₆-C₁₂-arylene, which is optionally condensed with further aromatic rings containing heteroatoms.

Another embodiment of the present invention is the above polycarbonate composition, wherein said polycarbonate composition comprises from 10 to 80 parts by weight of component A and from 90 to 20 parts by weight of component B, based in each case on the sum of the parts by weight of the components A and B.

Another embodiment of the present invention is the above polycarbonate composition, wherein said polycarbonate is a copolycarbonate comprising a proportion of monomer units of formula (1) of from 0.1 to 88 mol %, based on the sum of the moles of monomer units based on diphenols used.

Another embodiment of the present invention is the above polycarbonate composition, wherein component A comprises monomer units derived from compounds of formulae (1b) and (4b)

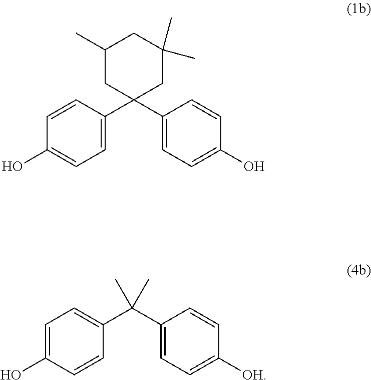

Another embodiment of the present invention is the above polycarbonate composition, further comprising from 0 to 5 parts by weight, based on the sum of the parts by weight of the components A and B, of additives as component C.

Yet another embodiment of the present invention is a shaped article, extrudate, film, or film laminate obtained from the above polycarbonate composition.

Yet another embodiment of the present invention is a shaped article, extrudate, or film comprising coextrusion layers obtained from the above polycarbonate composition.

Another embodiment of the present invention is the above shaped article, extrudate, film, or film laminate, wherein said shaped article, extrudate, film, or film laminate is a keypad in an electrical or electronic device, a lense, a screen/display cover, or an LED application.

Yet another embodiment of the present invention is a process for preparing the above polycarbonate compositions comprising the step of compounding a polycarbonate via the phase boundary process or melt transesterification process, wherein said polycarbonate comprises monomer units of formula (1) or based on diphenols of formulae (2) or (4).

### DESCRIPTION OF THE INVENTION

The present invention therefore relates to copolycarbonate compositions containing as component
A) 5 to 90 parts by weight, preferably 10 to 80 parts by weight (based on the sum of the parts by weight of the components A+B) of a copolycarbonate containing one or more monomer units derived from compounds of the diphenol building block of the formula (1)

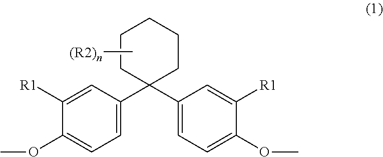

in which
   R1 represents hydrogen or C₁-C₄-alkyl, preferably hydrogen,
   R2 represents C₁-C₄-alkyl, preferably methyl,
   n represents 0, 1, 2 or 3, preferably 3,
      as component
B) 95 to 10 parts by weight, preferably 90 to 20 parts by weight (based on the sum of the parts by weight of the components A+B) of a (co)polycarbonate containing one or more monomer units of compounds of the general formula (2):

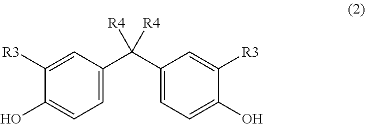

in which R3 represents H, linear or branched C₁-C₁₀-alkyl, preferably linear or branched C₁-C₆-alkyl, particularly preferably linear or branched C₁-C₄-alkyl, very particularly preferably H or C₁-alkyl (methyl)
and
in which R4 represents linear or branched C₁-C₁₀-alkyl, preferably linear or branched C₁-C₆-alkyl, particularly preferably linear or branched C₁-C₄-alkyl, very particularly preferably C₁-alkyl (methyl),
at least one of the components A or B containing, at least in part, a structural unit of the formula (3)

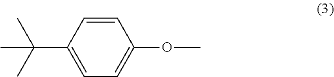

as a terminal group,
C) optionally 0 to 5 parts by weight, preferably 0 to 2 parts by weight, particularly preferably 0 to 1 part by weight (based in each case on the sum of the parts by weight of the components A+B) of additives.

### Component A

The monomer unit is introduced via one or more corresponding diphenols of the general formula (1):

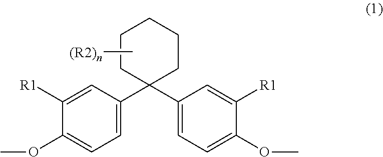

in which

R1 represents hydrogen or C₁-C₄-alkyl, preferably hydrogen,

R2 represents C₁-C₄-alkyl, preferably methyl,

n represents 0, 1, 2 or 3, preferably 3.

The diphenols of the formulae (1a)

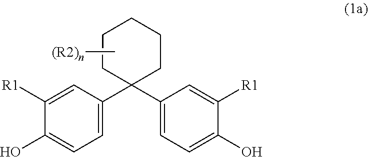

in which R1, R2 and n have the abovementioned meaning,
which are to be used according to the invention
and their use in homopolycarbonates are disclosed in part in the literature (DE 3918406).
1,1-Bis(4-hydroxyphenyl)-3,3,5-trimethylcyclohexane (bisphenol TMC) having the formula (1b):

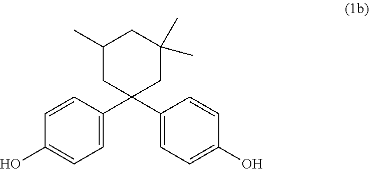

is particularly preferred.

In addition to one or more diphenols of the formulae (1), one or more diphenols selected from the group of compounds of the formula (4) may be present as a further monomer unit:

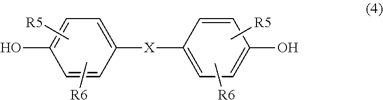

in which
R5 and R6, independently of one another, represent H, C₁-C₁₈-alkyl, C₁-C₁₈-alkoxy, halogen, such as Cl or Br, or represent in each case optionally substituted aryl or aralkyl, preferably H or C₁-C₁₂-alkyl, particularly preferably H or C₁-C₈-alkyl and very particularly preferably H or methyl, and
X represents a single bond, —SO₂—, —CO—, —O—, —S—, C₁-C₆-alkylene, C₂-C₅-alkylidene or C₅-C₆— cycloalkylidene, which may be substituted by C₁-C₆-alkyl, preferably methyl or ethyl, and furthermore represents C₆-C₁₂-arylene which may optionally be condensed with further aromatic rings containing heteroatoms.
   Preferably, X represents a single bond, C₁-C₅-alkylene, C₂-C₅-alkylidene, C₅-C₆-cycloalkylidene, —O—, —SO—, —CO—, —S—, —SO₂— or one for a radical of the formula

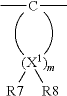

in which
R7 and R8 are individually selectable for each X¹ and, independently of one another, denote hydrogen or C₁-C₆-alkyl, preferably hydrogen, methyl or ethyl, and
X¹ denotes carbon and
m denotes an integer from 4 to 7, preferably 4 or 5, with the proviso that R7 and R8 are simultaneously alkyl on at least one atom X¹.

Hydroquinone, resorcinol, dihydroxybiphenyls, bis(hydroxyphenyl)alkanes, bis(hydroxyphenyl)cycloalkanes, bis(hydroxyphenyl) sulphides, bis(hydroxyphenyl)ethers, bis(hydroxyphenyl) ketones, bis(hydroxyphenyl) sulphones, bis(hydroxyphenyl) sulphoxides, α,α′-bis(hydroxyphenyl)diisopropylbenzenes and their compounds which are alkylated on the nucleus and halogenated on the nucleus and also α,ω-bis(hydroxyphenyl)polysiloxanes are mentioned by way of example for the diphenols of the formula (4), which can be used in addition to the diphenols of the formula (1) according to the invention.

Preferred diphenols of the formula (4) are, for example, 4,4′-dihydroxybiphenyl (DOD), 4,4′-dihydroxybiphenyl ether (DOD ether), 2,2-bis(4-hydroxyphenyl)propane (bisphenol A), 1,1-bis(4-hydroxyphenyl)-3,3,5-trimethylcyclohexane (bisphenol TMC), 1,1-bis(4-hydroxyphenyl)cyclohexane, 2,4-bis(4-hydroxyphenyl)-2-methylbutane, 1,1-bis(4-hydroxyphenyl)-1-phenylethane, 1,1-bis[2-(4-hydroxyphenyl)-2-propyl]benzene, 1,3-bis[2-(4-hydroxyphenyl)-2-propyl]benzene (bisphenol M), 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 2,2-bis(3,5-dichloro-4-hydroxyphenyl)propane and 2,2-bis(3,5-dibromo-4-hydroxyphenyl)propane.

Particularly preferred diphenols are, for example, 2,2-bis(4-hydroxyphenyl)propane (bisphenol A), 4,4′-dihydroxybiphenyl (DOD), 4,4′-dihydroxybiphenyl ether (DOD ether), 1,3-bis[2-(4-hydroxyphenyl)-2-propyl]benzene (bisphenol M), 2,2-bis(3,5-dimethyl-4-hydroxyphenyl)propane, 1,1-bis(4-hydroxyphenyl)-1-phenylethane, 2,2-bis(3,5-dichloro-4-hydroxyphenyl)propane, 2,2-bis(3,5-dibromo-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

Compounds of the general formula (4a)

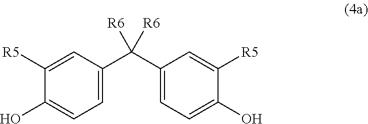

in which R5 represents H, linear or branched C₁-C₁₀-alkyl, preferably linear or branched C₁-C₆-alkyl, particularly preferably linear or branched C₁-C₄-alkyl, very particularly preferably H or C₁-alkyl (methyl), and
in which R6 represents linear or branched C₁-C₁₀-alkyl, preferably linear or branched C₁-C₆-alkyl, particularly preferably linear or branched C₁-C₄-alkyl, very particularly preferably C₁-alkyl (methyl),
   are very particularly preferred.

In particular, the diphenol (4b) is very particularly preferred here.

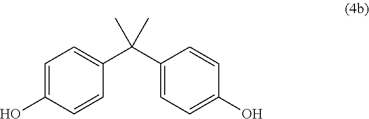

The diphenols of the general formulae (4) can be used both alone and as a mixture with one another. The diphenols are known from the literature or can be prepared by processes known from the literature (cf. for example H. J. Buysch et al., Ullmann's Encyclopedia of Industrial Chemistry, VCH, New York 1991, 5th Ed., Vol. 19, p. 348).

The proportion of the diphenols of the formula (1) in the copolycarbonate is 0.1-88 mol %, preferably 1-86 mol %, particularly preferably 5-84 mol % and very particularly preferably 10-82 mol % (based on the sum of the moles of diphenols used).

In a preferred embodiment, the polycarbonate composition contains 5 to 90 parts by weight, preferably 10 to 80 parts by weight, particularly preferably 51 to 80 parts by weight (based on the sum of the parts by weight of the components A+B) of component A.

The preferred diphenolate units of the copolycarbonates according to component A are derived from monomers having the general structures of the formulae (1) and (4) described above.

The copolycarbonate component of the polycarbonate compositions may be present as block and random copolycarbonate. Random copolycarbonates are particularly preferred.

The ratio of the frequency of the diphenolate monomer units in the copolycarbonate is obtained from the molar ratio of the diphenols used.

### Component B

Component B of the polycarbonate compositions is derived from one or more diphenol units of the formula (2):

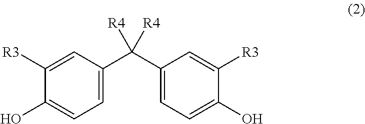

in which R3 represents H, linear or branched C₁-C₁₀-alkyl, preferably linear or branched C₁-C₆-alkyl, particularly preferably linear or branched C₁-C₄-alkyl, very particularly preferably H or C₁-alkyl (methyl), and
in which R4 represents linear or branched C₁-C₁₀-alkyl, preferably linear or branched C₁-C₆-alkyl, particularly preferably linear or branched C₁-C₄-alkyl, very particularly preferably C₁-alkyl (methyl).

In particular, the diphenol (4b) is very particularly preferred here.

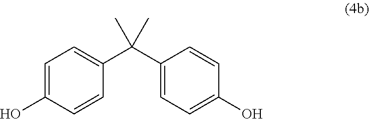

In addition to one or more diphenols of the formulae (2), one or more diphenols selected from the group consisting of the compounds of the formula (4) may be present as a further monomer unit, as already described for component A.

In a preferred embodiment, the polycarbonate composition contains 95 to 10 parts by weight, preferably 90 to 20 parts by weight, particularly preferably 80 to 49 parts by weight (based on the sum of the parts by weight of the components A+B) of component B.

At specific ratios of the components A and B, the polycarbonate compositions according to the invention have a lower melt viscosity and improved processing behaviour in injection moulding of the copolycarbonate compositions thus obtained.

This applies to compositions in which the component B is present in a concentration greater than or equal to 50% by weight and contains, in component B, a chain terminator containing alkyl groups.

The polycarbonates or copolycarbonates according to components A and/or B may also be branched. For this purpose, certain small amounts, preferably amounts between 0.05 and 5 mol %, particularly preferably 0.1-3 mol %, very particularly preferably 0.1-2 mol %, based on the moles of diphenols used, of trifunctional compounds, such as, for example, isatinbiscresol (IBK) or phloroglucinol, 4,6-dimethyl-2,4,6-tri(4-hydroxyphenyl)hept-2-ene; 4,6-dimethyl-2,4,6-tri(4-hydroxyphenyl)heptane; 1,3,5-tri(4-hydroxyphenyl)benzene; 1,1,1-tri(4-hydroxyphenyl)ethane (THPE); tri(4-hydroxyphenyl)phenylmethane; 2,2-bis[4,4-bis(4-hydroxyphenyl)cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenylisopropyl)phenyl)orthoterephthalic acid ester; tetra(4-hydroxyphenyl)methane; tetra(4-(4-hydroxyphenylisopropyl)phenoxy)methane; [symbol] -tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole; 1,4-bis(4′,4″-dihydroxytriphenyl)methyl)benzene and in particular 1,1,1-tri(4-hydroxyphenyl)ethane (THPE) and bis(3-methyl-4-hydroxyphenyl)-2-oxo-2,3-dihydroindole, are used as so-called branching agents. Isatinbiscresol and 1,1,1-tri-(4-hydroxyphenyl)-ethane (THPE) and bis-(3-methyl-4-hydroxyphenyl)-2-oxo-2,3-dihydroindole are preferably used as branching agents.

By using these branching agents, branched structures result. The resulting long chain branching generally leads to rheological properties of the resulting polycarbonates which manifest themselves in a structural viscosity in comparison with linear types.

For obtaining high molecular weight polycarbonates by the interfacial process, the alkali metal salts of diphenols are reacted with phosgene in the two-phase mixture. The molecular weight can be controlled by the amount of monophenols, which act as chain terminators, such as, for example, phenol, tert-butylphenol or cumylphenol, particularly preferably phenol, tert-butylphenol. Virtually exclusively linear polymers form in these reactions. This can be detected by end group analysis. By targeted use of so-called branching agents, as a rule polyhydroxylated compounds, branched polycarbonates are also obtained.

The amount of chain terminators to be used is 0.5 mol % to 10 mol %, preferably 1 mol % to 8 mol %, particularly preferably 2 mol % to 6 mol %, based on moles of diphenols used in each case. The chain terminators can be added before, during or after the phosgenation, preferably as a solution in a solvent mixture comprising methylene chloride and chlorobenzene (8-15% by weight).

The polycarbonates according to component A and B of the present invention can be produced by the interfacial process. There, the diphenols of the formulae (1) and (2) and possibly branching agents are dissolved in aqueous alkaline solution and reacted with a carbonate source, such as phosgene, optionally dissolved in a solvent, in a two-phase mixture comprising an aqueous alkaline solution, an organic solvent and a catalyst, preferably an amine compound. The reaction procedure can also be conducted in a multistep process.

Such processes for the preparation of polycarbonate are known in principle as two-phase interfacial processes, for example from H. Schnell, Chemistry and Physics of Polycarbonates, Polymer Reviews, Vol. 9, Interscience Publishers, New York 1964, page 33 et seq., and on Polymer Reviews, Vol. 10, “Condensation Polymers by Interfacial and Solution Methods”, Paul W. Morgan, Interscience Publishers, New York 1965, Chapter VIII, page 325, and the underlying conditions are therefore familiar to the person skilled in the art.

The concentration of the diphenols in the aqueous alkaline solution is 2 to 25% by weight, preferably 2 to 20% by weight, particularly preferably 2 to 18% by weight and very particularly preferably 3 to 15% by weight. The aqueous alkaline solution consists of water in which hydroxides of alkali metals or alkaline earth metals are dissolved. Sodium and potassium hydroxides are preferred.

With the use of phosgene as a carbonate source, the volume ratio of aqueous alkaline solution to organic solvent is 5:95 to 95:5, preferably 20:80 to 80:20, particularly preferably 30:70 to 70:30 and very particularly preferably 40:60 to 60:40. The molar ratio of diphenol to phosgene is less than 1:10, preferably less than 1:6, particularly preferably less than 1:4 and very particularly preferably less than 1:3. The concentration of the branched polycarbonates and copolycarbonates according to the invention in the organic phase is 1.0 to 25% by weight, preferably 2 to 20% by weight, particularly preferably 2 to 18% by weight and very particularly preferably 3 to 15% by weight.

The concentration of the amine compound, based on the amount of diphenol used, is 0.1 to 10 mol %, preferably 0.2 to 8 mol %, particularly preferably 0.3 to 6 mol % and very particularly preferably 0.4 to 5 mol %.

Diphenols are to be understood as meaning diphenol mixtures selected from the abovementioned compounds, with proportions of the abovementioned branching agents. The carbonate source is phosgene, diphosgene or triphosgene, preferably phosgene. Where phosgene is used, a solvent may optionally be dispensed with and the phosgene may be passed directly into the reaction mixture.

Tertiary amines, such as triethylamine or N-alkylpiperidines, may be used as a catalyst. Suitable catalysts are trialkylamines and 4-(dimethylamino)pyridine. Triethylamine, tripropylamine, triisopropylamine, tributylamine, triisobutylamine, N-methylpiperidine, N-ethylpiperidine and N-propylpiperidine are particularly suitable.

Halogenated hydrocarbons, such as methylene chloride, chlorobenzene, dichlorobenzene, trichlorobenzene or mixtures thereof, or aromatic hydrocarbons, such as, for example, toluene or xylenes, are suitable as an organic solvent. The reaction temperature may be −5° C. to 100° C., preferably 0° C. to 80° C., particularly preferably 10° C. to 70° C. and very particularly preferably 10° C. to 60° C.

The preparation of the polycarbonates according to components A and/or B by the melt transesterification process, in which the diphenols are reacted with diaryl carbonates, generally diphenyl carbonate, in the presence of catalysts, such as alkali metal salts, ammonium or phosphonium compounds, in the melt, is also possible.

The melt transesterification process is described, for example, in Encyclopedia of Polymer Science, Vol. 10 (1969), Chemistry and Physics of Polycarbonates, Polymer Reviews, H. Schnell, Vol. 9, John Wiley and Sons, Inc. (1964), and DE-C 10 31 512.

In the transesterification process the aromatic dihydroxy compounds already described in the case of the phase boundary process are transesterified with carbonic acid diesters with the aid of suitable catalysts and optionally further additives in the melt.

In the context of the invention, carbonic acid diesters are those of the formulae (5) and (6)

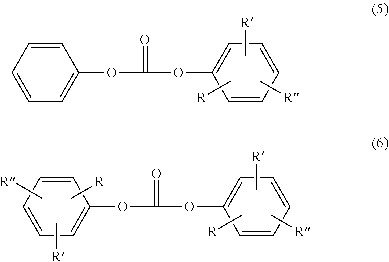

in which
R, R′ and R″, independently of one another, may represent H, optionally branched C₁-C₃₄-alkyl/cycloalkyl, C₇-C₃₄-alkaryl or C₆-C₃₄-aryl,
   for example
   diphenyl carbonate, butylphenyl phenyl carbonate, dibutylphenyl carbonate, isobutylphenyl phenyl carbonate, diisobutylphenyl carbonate, tert-butylphenyl phenyl carbonate, di-tert-butylphenyl carbonate, n-pentylphenyl phenyl carbonate, di(n-pentylphenyl) carbonate, n-hexylphenyl phenyl carbonate, di(n-hexylphenyl) carbonate, cyclohexylphenyl phenyl carbonate, dicyclohexylphenyl carbonate, phenylphenol phenyl carbonate, diphenylphenol carbonate, isooctylphenyl phenyl carbonate, diisooctylphenyl carbonate, n-nonylphenyl phenyl carbonate, di(n-nonylphenyl) carbonate, cumylphenyl phenyl carbonate, dicumylphenyl carbonate, naphthylphenyl phenyl carbonate, dinaphthylphenyl carbonate, di-tert-butylphenyl phenyl carbonate, di(di-tert-butylphenyl) carbonate, dicumylphenyl phenyl carbonate, di(dicumylphenyl) carbonate, 4-phenoxyphenyl phenyl carbonate, di(4-phenoxyphenyl) carbonate, 3-pentadecylphenyl phenyl carbonate, di(3-pentadecylphenyl) carbonate, tritylphenyl phenyl carbonate, ditritylphenyl carbonate,
   preferably diphenyl carbonate, tert-butylphenyl phenyl carbonate, di-tert-butylphenyl carbonate, phenylphenol phenyl carbonate, diphenylphenol carbonate, cumylphenyl phenyl carbonate, dicumylphenyl carbonate, particularly preferably diphenyl carbonate.

It is also possible to use mixtures of said carbonic acid diesters.

The proportion of carbonic acid esters is 100 to 130 mol %, preferably 103 to 120 mol %, particularly preferably 103 to 109 mol %, based on the dihydroxy compound.

In the context of the invention, basic catalysts, such as, for example, alkali metal and alkaline earth metal hydroxides and oxides, but also ammonium or phosphonium salts, referred to below as onium salts, are used as catalysts in the melt transesterification process, as described in the stated literature. Preferably onium salts, particularly preferably phosphonium salts, are used. Phosphonium salts in the context of the invention are those of the following general formula (7)

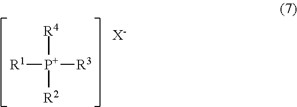

in which
R¹⁻⁴ may be the same or different C₁-C₁₀-alkyls, C₆-C₁₀-aryls, C₇-C₁₀-aralkyls or C₅-C₆-cycloalkyls, preferably methyl or C₆-C₁₄-aryls, particularly preferably methyl or phenyl, and
X⁻ may be an anion, such as hydroxide, sulphate, hydrogen sulphate, bicarbonate, carbonate, a halide, preferably chloride, or an alcoholate of the formula OR, in which R may be C₆-C₁₄-aryl or C₇-C₁₂-aralkyl, preferably phenyl.
   Preferred catalysts are
   tetraphenylphosphonium chloride, tetraphenylphosphonium hydroxide, tetraphenylphosphonium phenolate, particularly preferably tetraphenylphosphonium phenolate.

The catalysts are preferably used in amounts of 10⁻⁸ to 10⁻³ mol, based on one mole of diphenol, particularly preferably in amounts of 10⁻⁷ to 10⁻⁴ mol.

Further catalysts may be used alone or optionally in addition to the onium salt in order to increase the rate of the polymerization. These include the salts of alkali metals and alkaline earth metals, such as hydroxides, alkoxides and aryl oxides of lithium, sodium and potassium, preferably hydroxide, alkoxide or aryl oxide salts of sodium. Sodium hydroxide and sodium phenolate are most preferred. The amounts of the cocatalyst may be in the range from 1 to 200 ppb, preferably 5 to 150 ppb and most preferably 10 to 125 ppb, calculated in each case as sodium.

The transesterification reaction of the aromatic dihydroxy compound and of the carbonic acid diester in the melt is preferably carried out in two stages. In the first stage, the melting of the aromatic dihydroxy compound and of the carbonic acid diester at temperatures of 80-250° C., preferably 100-230° C., particularly preferably 120-190° C., under atmospheric pressure in 0-5 hours, preferably 0.25-3 hours, takes place. After addition of the catalyst, the oligocarbonate is prepared from the aromatic dihydroxy compound and the carbonic acid diester by applying a vacuum (up to 2 mm Hg) and increasing the temperature (up to 260° C.), by distilling off the monophenol. The main amount of vapours from the process occurs here. The oligocarbonate thus prepared has a weight average molar mass M_{W} (determined by measurement of the relative solution viscosity in dichloromethane or in mixtures of equal amounts by weight of phenol/o-dichlorobenzene, calibrated by light scattering) in the range from 2000 g/mol to 18 000 g/mol, preferably from 4000 g/mol to 15 000 g/mol.

In the second stage, the polycarbonate is prepared in the polycondensation by further increasing the temperature to 250-320° C., preferably 270-295° C., and a pressure of <2 mm Hg.

The catalysts may also be used in combination (two or more) with one another.

With the use of alkali metal/alkaline earth metal catalysts, it may be advantageous to add the alkali metal/alkaline earth metal catalysts at a later time (for example after the oligocarbonate synthesis, in the polycondensation in the second stage).

In the process according to the invention, the reaction of the aromatic dihydroxy compound and of the carbonic acid diester to give the polycarbonate can be carried out batchwise or preferably continuously, for example in stirred vessels, thin-film evaporators, falling-film evaporators, stirred vessel cascades, extruders, kneaders, simple disc reactors and high-viscosity disc reactors.

Analogously to the interfacial process, branched poly- or copolycarbonates can be prepared by using polyfunctional compounds.

In a preferred embodiment, component B is prepared by the melt transesterification process.

The relative solution viscosity of the copolycarbonates used, determined according to DIN 51562, is preferably in the range of=1.15−1.35.

Polycarbonate compositions in which component B or component A and component B contain, at least in part, a structural unit of the formula (3) as a terminal group are particularly preferred.

### Component C

The present invention furthermore relates to compositions containing abovementioned copolycarbonate with alkylphenol of the formula (3) as a terminal group, and optionally at least one additive selected from the group consisting of the additives customary for these thermoplastics, such as fillers, carbon black, UV stabilizers, IR stabilizers, heat stabilizers, antistatic agents and pigments, colorants in the customary amounts; optionally, the demoulding behaviour, the flow behaviour and/or the flame retardance can also be improved by addition of external release agents, flow improvers and/or flameproofing agents, such as sulphonic acid salts, PTFE polymers or PTFE copolymers, brominated oligocarbonates or oligophosphates and phosphazenes (e.g. alkyl and aryl phosphites and phosphates, alkyl and arylphosphanes, low molecular weight carboxylic acid esters, halogen compounds, salts, chalk, quartz powder, glass and carbon fibres, pigments and the combination thereof. Such compounds are described, for example, in WO 99/55772, pages 15-25, and in “Plastics Additives”, R. Gächter and H. Müller, Hanser Publishers 1983).

The composition generally contains 0 to 5, preferably 0 to 2.5, particularly preferably 0 to 1.6, % by weight, very particularly preferably 0.04 to 1.0% by weight, in particular very particularly preferably 0.04 to 0.8% by weight (based on the total composition) of additives.

The release agents optionally added to the compositions according to the invention are preferably selected from the group consisting of pentaerythrityl tetrastearate, glyceryl monostearate, long-chain fatty acid esters, such as, for example, stearyl stearate and propanediol stearate, and mixtures thereof. The release agents are used in amounts of 0.05% by weight to 2.00% by weight, based on the moulding material, preferably in amounts of 0.1% by weight to 1.0% by weight, particularly preferably in amounts of 0.15% by weight to 0.60% by weight and very particularly preferably in amounts of 0.2% by weight to 0.5% by weight, based on the moulding material.

Suitable additives are described, for example, in “Additives for Plastics Handbook, John Murphy, Elsevier, Oxford 1999”, in “Plastics Additives Handbook, Hans Zweifel, Hanser, Munich, 2001”.

Examples of suitable antioxidants or heat stabilizers are:

Alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxyphenyl)propionic acid, esters of 3,5-di-tert-butyl-4-hydroxyphenylacetic acid, amides of β-(3,5-di-tert-butyl-4-hydroxyphenyl)propionic acid, suitable thiosynergistic agents, secondary antioxidants, phosphites and phosphonites, benzofuranones and indolinones.

Preferably, tris(2,4-di-tert-butylphenyl) phosphite (Irgafos 168), tetrakis(2,4-di-tert-butylphenyl) [1,1-b]phenyl]-4,4′-diylbisphosphonite, triisoctyl phosphate (TOF), octadecyl 3-(3,5-di-tert-butyl-4-hydroxyphenyl)propionate (Irganox 1076), bis(2,4-dicumylphenyl)pentaerythritol diphosphite (Doverphos S-9228-PC), bis(2,6-di-tert-butyl-4-methylphenyl)pentaerythritol diphosphite (ADK STAB PEP-36) or triphenylphosphine (TPP) are suitable as a heat stabilizer. They are used alone or as a mixture (e.g. Irganox B900 or Doverphos S-9228-PC with Irganox B900 or Irganox 1076 or triphenylphosphine (TPP) with triisoctylphosphine (TOF)).

Suitable complexing agents for heavy metals and for neutralizing traces of alkali are o/m-phosphoric acids, completely or partly esterified phosphates or phosphites.

Suitable light stabilizers (UV absorbers) are 2-(2′-hydroxyphenyl)benzotriazoles, 2-hydroxybenzophenones, esters of substituted and unsubstituted benzoic acids, acrylates, sterically hindered amines, oxamides and 2-(hydroxyphenyl)-1,3,5-triazines or substituted hydroxyalkoxyphenyl, 1,3,5-triazoles; substituted benzotriazoles, such as, for example, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)-5-chlorobenzotriazole, 2-(2′-hydroxy-3′,5′-tert-butylphenyl)-5-chlorobenzotriazole, 2-(2′-hydroxy-5′-tert-octylphenyl)benzotriazole, 2-(2′-hydroxy-3′,5′-di-tert-amylphenyl)benzo-triazole, 2-[2′-hydroxy-3′-(3″,4″,5″,6″-tetrahydrophthalimidoethyl)-5′-methylphenyl]benzotriazole and 2,2′-methylenebis[4-(1,1,3,3-tetramethylbutyl)-6-(2H-benzotriazol-2-yl)phenol], are preferred.

Furthermore, suitable UV stabilizers are selected from the group consisting of benzotriazoles (e.g. Tinuvins from BASF), Triazine CGX-06 from BASF), benzophenones (Uvinuls from BASF), cyanoacrylates (Uvinuls from BASF), cinnamic acid esters and oxalanilides and mixtures of these UV stabilizers.

Examples of suitable UV absorbers are:
a) Malonic esters of the formula (I):

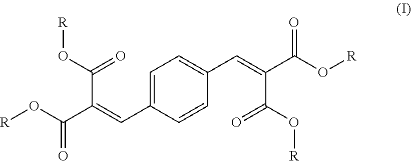

in which R denotes alkyl. R preferably represents C₁-C₆-alkyl, in particular C₁-C₄-alkyl and particularly preferably ethyl.
b) Benzotriazole derivatives according to formula (II):

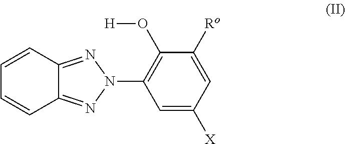

In formula (II), R^{o} are present and X are identical or different and denote H or alkyl or alkylaryl.

Tinuvin® 329 where X=1,1,3,3-tetramethylbutyl and R^{o}=H, Tinuvin® 350 where X=tert-butyl and R^{o}=2-butyl and Tinuvin® 234 where X and R^{o}=1,1-dimethyl-1-phenyl are preferred.
c) Dimeric benzotriazole derivatives according to formula (III):

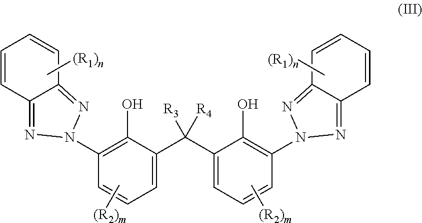

In formula (III), R1 and R2 are identical or different and denote H, halogen, C₁-C₁₀-alkyl, C₅-C₁₀-cycloalkyl, C₇-C₁₃-aralkyl, C₆-C₁₄-aryl, —OR5 or —(CO)—O—R5 where R5=H or C1-C4-alkyl.

In formula (III), R3 and R4 are likewise identical or different and denote H, C₁-C₄-alkyl, C₅-C₆-cycloalkyl, benzyl or C₆-C₁₄-aryl.

In formula (III), m denotes 1, 2 or 3 and n denotes 1, 2, 3 or 4.

Tinuvin® 360 where R1=R3=R4=H; n=4; R2=1,1,3,3-tetramethylbutyl; m=1 is preferred.

d) Dimeric benzotriazole derivatives according to formula (IV):

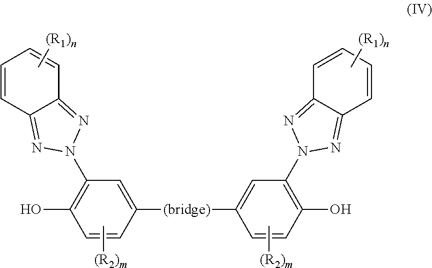

in which the bridge denotes

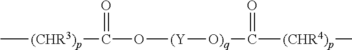

R, R, m and n have the meanings stated for formula (III), and in which p is an integer from 0 to 3, q is an integer from 1 to 10, Y is —CH₂—CH₂—, —(CH₂)₃—, —(CH₂)₄—, —(CH₂)₅—, —(CH₂)₆—, or CH(CH₃)—CH₂— and R3 and R4 have the meaning stated for formula (III).

Tinuvin® 840 where R1=H; n=4; R2=tert-butyl; m=1; R2 is attached in the ortho-position to the OH group; R3=R4=H; p=2; Y=—(CH₂)₅—; q=1 is preferred.

e) Triazine derivatives according to formula (V):

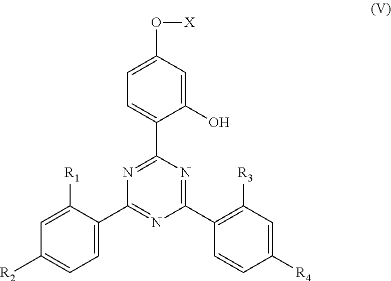

in which R1, R2, R3, R4 are identical or different and are H, alkyl, aryl, CN or halogen and X is alkyl, preferably isooctyl.
Tinuvin® 1577 where R1=R2=R3=R4=H; X=hexyl, and Cyasorb® UV-1 164 where R1=R2=R3=R4=methyl; X=octyl, is preferred.
f) Triazine derivatives of the following formula (Va):

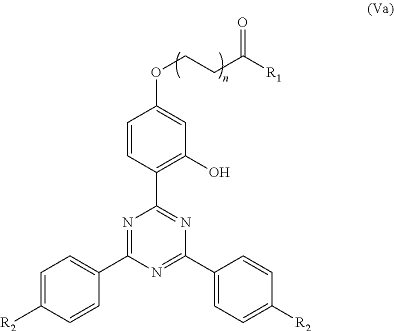

in which R1 denotes C₁-C₁₇-alkyl, R2 denotes H or C₁-C₄-alkyl and n is 0 to 20.
g) Dimeric triazine derivatives of the formula (VI):

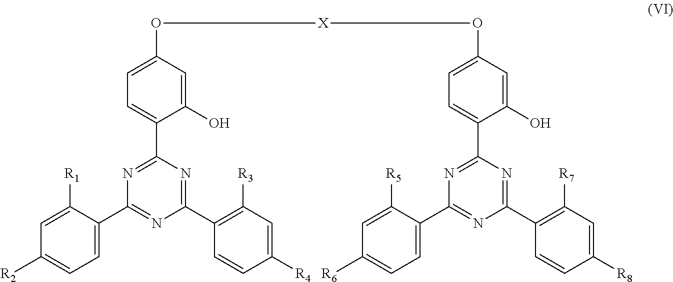

in which R1, R2, R3, R4, R5, R6, R7, R8 may be identical or different and denote H, alkyl, CN or halogen and X is alkylidene, preferably methylidene or —(CH₂ CH₂—O—)n-C(═O)— and n represents 1 to 10, preferably 1 to 5, in particular 1 to 3.
h) Diaryl cyanoacrylates of the formula (VII):

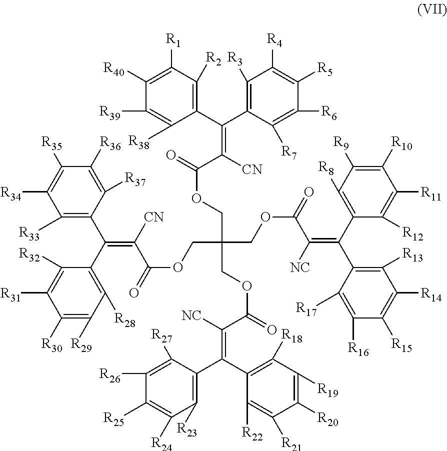

in which R to R40 may be identical or different and denote H, alkyl, CN or halogen.
Uvinul® 3030 where R1 to R40=H is preferred.

Particularly preferred UV stabilizers for the moulding materials according to the invention are compounds from the group consisting of the benzotriazoles (b) and dimeric benzotriazoles (c and d), the malonic esters (a) and the cyanoacrylates (h) and mixtures of these compounds.

The UV stabilizers are used in amounts of 0.01% by weight to 2.0% by weight, based on the moulding material, preferably in amounts of 0.05% by weight to 1.00% by weight, particularly preferably in amounts of 0.08% by weight to 0.5% by weight and very particularly preferably in amounts of 0.1% by weight to 0.4% by weight, based on the total composition.

Polypropylene glycols, alone or in combination with, for example, sulphones or sulphonamides as stabilizers, can be used to prevent damage by gamma rays.

These and other stabilizers can be used individually or in combinations and are added to the polymer in said forms.

Suitable flame-retardant additives are phosphate esters, i.e. triphenyl phosphate, resorcinol diphosphoric acid esters, bromine-containing compounds, such as brominated phosphoric acid esters, brominated oligocarbonates and polycarbonates, and preferably salts of fluorinated organic sulphonic acids.

Suitable tougheners are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

Furthermore, colorants, such as organic dyes or pigments or inorganic pigments, carbon black, IR absorbers, individually, as a mixture or in combination with stabilizers, glass fibres, (hollow) glass spheres, inorganic fillers, such as, for example, titanium dioxide or barium sulphate, may be added.

The polycarbonates and polycarbonate compositions according to the invention can be processed in a customary manner on customary machines, for example on extruders or injection moulding machines, to give any desired mouldings or shaped articles or to give films or sheets or bottles.

The polycarbonate compositions according to the invention, optionally as a mixture with other thermoplastics and/or customary additives, can be processed to give any desired mouldings/extrudates and used wherever known polycarbonates, polyester carbonates and polyesters are already used:
1. safety panes, which are known to be required in many areas of buildings, vehicles and aircraft, and as identification plates of helmets.
2. production of films and film laminates.
3. automobile headlamps, bezels, indicators, reflectors.
4. as translucent plastics having a content of glass fibres for lighting purposes, as translucent plastics having a content of barium sulphate, titanium dioxide and/or zirconium oxide or

TABLE 2

| | | Example: | | | | | | | | |
|---|---|---|---|---|---|---|---|---|---|---|
| | | 11 | 12 | 13 | 14 | 15 | 16* | 17* | 18* | 19* |
| BPA Homo PC 3 | % | 90 | 80 | 70 | 50 | 40 | — | — | — | — |
| BPA Homo PC 4 (comparison) | % | — | — | — | — | — | 90 | 80 | 70 | 50 |
| CoPC 1 | % | 10 | 20 | 30 | 50 | 60 | 10 | 20 | 30 | 50 |
| Results | | | | | | | | | | |
| MVR 300° C./1.2 kg | ml/10 min | 8.1 | 7.4 | 6.4 | 5.2 | 4.5 | 9.2 | 7.9 | 7.0 | 5.5 |
| IMVR 300° C./1.2 kg 20′ | ml/10 min | 8.4 | 7.5 | 6.6 | 5.3 | 4.7 | 9.3 | 8.2 | 7.3 | 5.6 |
| ΔMVR/IMVR 20′ | | 0.3 | 0.1 | 0.2 | 0.1 | 0.2 | 0.1 | 0.3 | 0.3 | 0.1 |
| Vicat VST B50 | ° C. | 151.1 | 152.4 | 154.6 | 159.5 | 157.9 | 148.1 | 150.1 | 152.1 | 156.5 |

*Comparative example

As is clearly evident from Table 1 and 2, the compositions 1-5 and 11-15 according to the invention each have a substantially higher Vicat temperature than the comparative polycarbonate compositions 6-10 and 16-19.
In the experiments in Table 1 and 2, it was therefore shown that the preparation of the copolycarbonate compositions prepared by a compounding step of the mixtures according to the invention leads to higher heat distortion resistances.
Compounds with comparable heat distortion resistances (Vicat temperature) therefore need a minor amount of high-Tg polycarbonate.

1. A polycarbonate composition comprising:
A) from 5 to 90 parts by weight, based on the sum of the parts by weight of components A and B, of a copolycarbonate comprising one or more monomer units derived from compounds of the diphenol building block of formula (1) 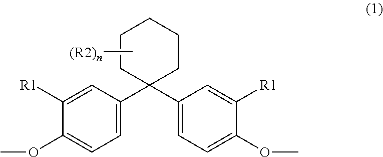
wherein
R1 is hydrogen or C₁-C₄-alkyl,
R2 is C₁-C₄-alkyl, and
n is 0, 1, 2 or 3,
and
B) from 95 to 10 parts by weight, based on the sum of the parts by weight of the components A and B, of a (co)polycarbonate comprising one or more monomer units of compounds of formula (2): 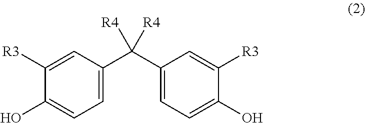
wherein
R3 is H or linear or branched C₁-C₁₀-alkyl, and
R4 is linear or branched C₁-C₁₀-alkyl,
wherein at least one of components A or B comprise, at least in part, a structural unit of formula (3) 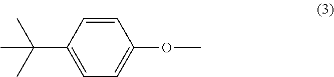
as a terminal group.

2. The polycarbonate composition of claim 1, wherein R1 is hydrogen, R2 is methyl, and n is 3.

3. The polycarbonate composition of claim 1, wherein at least one of components A or B additionally comprises monomer units based on diphenols of formula (4) 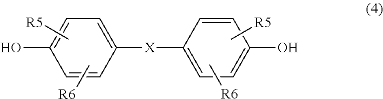
wherein
R5 and R6, are, independently of one another, hydrogen, C₁-C₁₈-alkyl, C₁-C₁₈-alkoxy, halogen, and optionally substituted aryl or aralkyl, and
X is a single bond, —SO₂—, —CO—, —O—, —S—, C₁- to C₆-alkylene, C₂- to C₅-alkylidene or C₅- to C₆-cycloalkylidene, wherein said C₁- to C₆-alkylene, C₂- to C₅-alkylidene, or C₅- to C₆-cycloalkylidene is optionally substituted with C₁-C₆-alkyl, or C₆-C₁₂-arylene, which is optionally condensed with further aromatic rings containing heteroatoms.

4. The polycarbonate composition of claim 1, wherein said polycarbonate composition comprises from 10 to 80 parts by weight of component A and from 90 to 20 parts by weight of component B, based in each case on the sum of the parts by weight of the components A and B.

5. The polycarbonate composition of claim 1, wherein said polycarbonate is a copolycarbonate comprising a proportion of monomer units of formula (1) of from 0.1 to 88 mol %, based on the sum of the moles of monomer units based on diphenols used.

6. The polycarbonate composition of claim 1, wherein component A comprises monomer units derived from compounds of formulae (1b) and (4b)

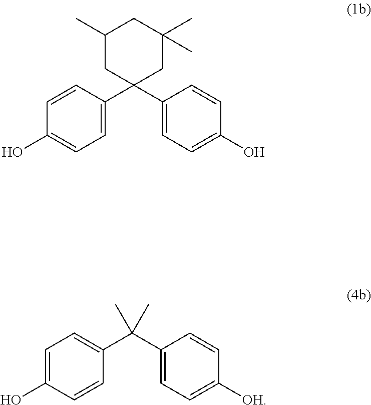

7. The polycarbonate composition of claim 1, further comprising from 0 to 5 parts by weight, based on the sum of the parts by weight of the components A and B, of additives as component C.

8. A shaped article, extrudate, film, or film laminate obtained from the polycarbonate composition of claim 1.

9. A shaped article, extrudate, or film comprising coextrusion layers obtained from the polycarbonate composition of claim 1.

10. The shaped article, extrudate, film, or film laminate of claim 8, wherein said shaped article, extrudate, film, or film laminate is a keypad in an electrical or electronic device, a lense, a screen/display cover, or an LED application.

11. A process for preparing polycarbonate compositions according to claim 1 comprising the step of compounding a polycarbonate via the phase boundary process or melt transesterification process, wherein said polycarbonate comprises monomer units of formula (1) or based on diphenols of formulae (2) or (4).
